(19) United States
(12) Patent Application Publication
(10) Pub. No.: US 2016/0070555 A1
(43) Pub. Date: Mar. 10, 2016

(54) AUTOMATED TENANT UPGRADES FOR MULTI-TENANT SERVICES

(71) Applicant: Microsoft Corporation, Redmond, WA (US)

(72) Inventors: Mingfeng Xiong, Sammamish, WA (US); Samuel Kabue, Seattle, WA (US); Pritvinath Obla, Bellevue, WA (US); Lei Sun, Bellevue, WA (US)

(73) Assignee: Microsoft Corporation, Redmond, WA (US)

(21) Appl. No.: 14/481,559

(22) Filed: Sep. 9, 2014

(51) Int. Cl. G06F 9/445; G06F 11/36

(52) U.S. Cl. CPC G06F 8/65; G06F 11/3668

(57) ABSTRACT

Automated tenant upgrades are provided for moving tenants in a multi-tenant service from a source scale unit to a target scale unit. Before real tenants are moved, test tenants are moved and the target scale unit health is monitored. Monitoring simulates user activity in the test tenants to look for problems with the target scale unit. If no significant problems are detected after moving the test tenants, real tenants are upgraded in batches. Target scale unit monitoring continues while real tenants are being upgraded and problems reported by real tenants already upgraded to the target scale unit are also considered when assessing the target scale unit health. If a significant problem occurs, tenant upgrades are paused until the issue is resolved. Automated tenant upgrades improve usability of a multi-tenant service by minimizing the service disruptions due to upgrade problems while providing cost effective upgrades to the latest builds.

### BACKGROUND

In a production multi-tenant service, customers are regularly upgraded from one farm to another for various reasons. Customers are constantly upgraded to the latest version of an application. During an upgrade, a number of operations are performed that could potentially downgrade the customer experience and, in the case of a serious issue encountered during the upgrade process, could potentially result in downtime for customers. Even if a problem is identified, customers that have already been upgraded potentially suffer. In any event, manually upgrading tenants is a very labor intensive process involving lots of oversight to watch for such problems and is costly for the multi-tenant service operator.

It is with respect to these and other considerations that the present invention has been made. Although relatively specific problems have been discussed, it should be understood that aspects of the invention disclosed herein should not be limited to solving the specific problems identified in the background.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Aspects of the automated tenant upgrade system include upgrading of tenants from a source scale unit to a target scale unit. To minimize the potential for customers to experience problems as a result of being upgraded to a different scale unit, the automated tenant upgrade system makes use of test tenants provisioned to the source scale unit. Before moving any real tenants, test tenants are upgraded to the target scale unit. Test tenants may be stored in separate databases from real tenants. If sufficient numbers of test tenants or databases containing test tenants are not available in the source scale unit, no tenants are upgraded to the target scale unit.

Once test tenants are moved to the target scale unit, the health of the target scale unit is tested and monitored. If the target scale unit appears to be healthy, real tenants are upgraded to the target scale unit. Monitoring of the target scale unit continues throughout the upgrade process and real tenants continue to be upgraded as long as the target scale unit is not determined to be unhealthy. If problems with the target scale unit are detected or reported by users of real tenants that have been upgraded to the target scale unit, the upgrade process is automatically paused. Once the issues with the target scale unit are resolved, the upgrade of real tenants automatically resumes. This process continues until all real tenants have been upgraded to the target scale unit.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout the several views:

FIG. 1 is a system diagram illustrating aspects of the automated tenant upgrade system;

FIG. 2 is a high level flowchart illustrating aspects of a method for automated tenant upgrade in a multi-tenant service;

FIG. 3 is a block diagram illustrating physical components of a computing device suitable for practicing aspects of the present invention;

FIG. 4A illustrates a mobile computing device suitable for practicing aspects of the present invention;

FIG. 4B is a block diagram illustrating an architecture for a mobile computing device suitable for practicing aspects of the present invention; and

FIG. 5 is a simplified block diagram of a distributed computing system with which aspects of the present invention may be practiced.

### DETAILED DESCRIPTION

Various aspects of the present invention are described more fully below with reference to the accompanying drawings, which form a part hereof, and which show specific exemplary aspects of the present invention. However, the present invention may be implemented in many different forms and should not be construed as limited to the aspects set forth herein; rather, these aspects are provided so that this disclosure will be thorough and complete, and will fully convey the scope of the various aspects to those skilled in the art. Aspects may be practiced as methods, systems, or devices. Accordingly, implementations may be practiced using hardware, software, or a combination of hardware and software. The following detailed description is, therefore, not to be taken in a limiting sense.

Aspects of an automated tenant upgrade system and accompanying method are described herein and illustrated in the accompanying figures. Automated tenant upgrades move tenants in a multi-tenant service from a source scale unit to a target scale unit. Before real tenants are moved, test tenants are moved and the health of the target scale unit is monitored. Monitoring simulates user activity in the test tenants to look for problems with the target scale unit. If no significant problems are detected after moving the test tenants, real tenants are upgraded in batches until all real tenants have been moved. Target scale unit monitoring continues while real tenants are being upgraded and problems reported by real tenants already upgraded to the target scale unit are also considered when assessing the target scale unit health. If a significant problem occurs, real tenant upgrades are paused until the issue is resolved. Automated tenant upgrades improve usability of a multi-tenant service by minimizing the service disruptions due to upgrade problems while providing cost effective upgrades to the latest builds.

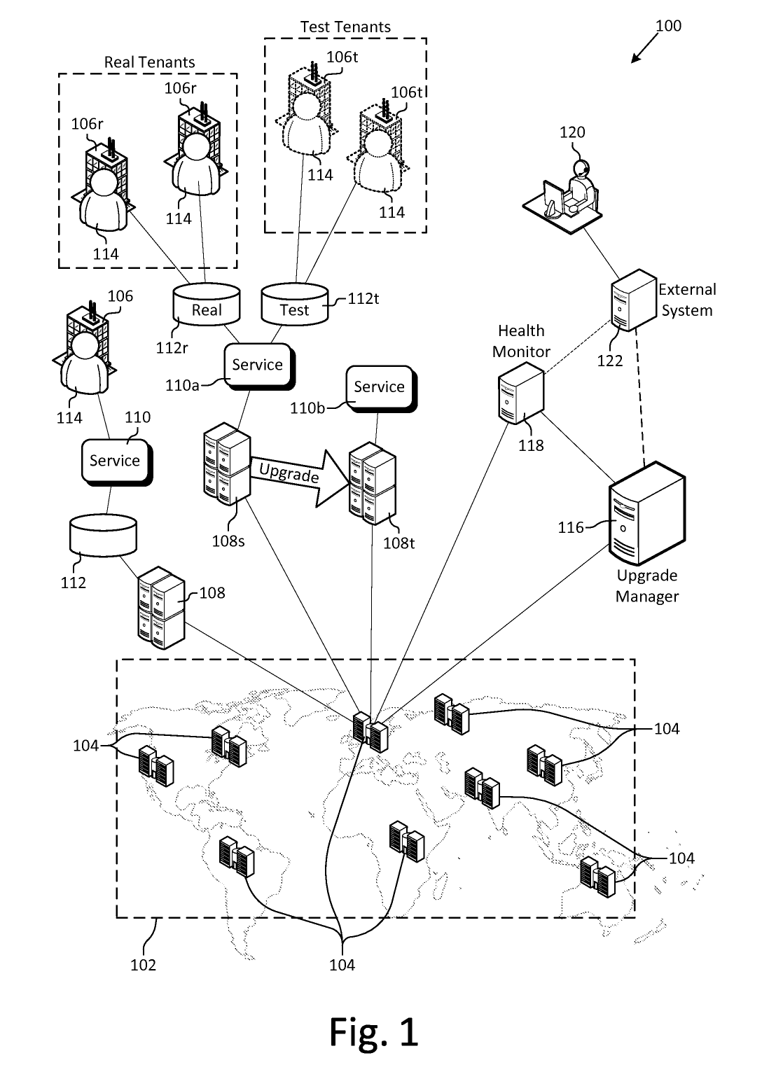

FIG. 1 is a system diagram illustrating aspects of the automated tenant upgrade system 100. The multi-tenant service 102 is typically made up of a number of data centers 104 that provide shared services, software, and data storage for customers. As shown, the multi-tenant service is a distributed service, such as a cloud-based service, having multiple, geographically distributed data centers 104. When customers subscribe to the multi-tenant service, a tenant 106 is typically provisioned to a scale unit 108 hosting a service 110 in a data center 104 that is geographically located near the customer's geographic location. The tenant 106 generally refers to the top level object in the hierarchical representation of a customer (e.g., a company). One or more databases 112 storing information about tenants 106 may be associated with each scale unit 108. One or more users 114 may be associated with each tenant 106.

As used herein, a scale unit 108 is a capacity unit of the multi-tenant service 102 providing some or all application functionalities to tenants (e.g., run and serve applications) and hosting customer content. The scale unit 108 may encompass the software resources (e.g., web applications, service applications, and workloads), as well as the underlying the hardware (e.g., the set of connected servers and data storage systems within the data center 104) that work together to serve user requests. Examples of applications that may be provided as a service by a multi-tenant service include, without limitation, word processing, mail, messaging, conferencing, task management, calendaring, collaboration, contact information management, note taking, document management, content management, presentation, spreadsheet, database, media, and drawing applications.

An upgrade manager 116 manages upgrades of tenants from a source scale unit 108s to a target scale unit 108t. A typical scenario is upgrading tenants 106 from an older build or version of a service 110a to newer one 110b; however, the automated tenant upgrade system is well suited for and may be used in other scenarios besides an upgrade. To minimize the potential for customers to experience problems as a result of being upgraded to a different scale unit, the automated tenant upgrade system 100 makes use of test tenants 106t. As used herein, the term “tenant” broadly encompasses both real tenants 106r, which are associated with a customer, and test tenants 106t, which represent fictitious entities. Generally, once created, there is no meaningful difference between a real tenant and a test tenant from a functionality standpoint, which is desirable as test tenants are intended to be used to mimic real tenants for testing operation of production multi-tenant services. Aspects of the automated tenant upgrade system 100 include provisioning test tenants 106t in test-only databases 112t that are separate from the databases 112r where real tenants are provisioned.

Before moving any real tenants 106r, the upgrade manager 116 moves test tenants 106t to the target scale unit 108t. Once test tenants 106t are moved to the target scale unit 108t, a health monitor 118 checks the health of the target scale unit 108t. The health of the target scale unit may be monitored for a selected amount of time after the test tenants have been upgraded before real tenants are moved. The health monitor 118 continues to monitor the health of the target scale unit throughout the entire upgrade.

Deterministic criteria may be applied by the health monitor 118 to decide whether the target scale unit 108t is healthy or not based on information obtained using a variety of monitoring technologies, including testing user perceived scenarios and monitoring health signals from the scale unit. Examples of health signals may include, without limitation, self-diagnostics reporting provided by software or hardware of the scale unit and error messages/logs generated by the scale unit. When issues with the target scale unit 108t are detected, the health monitor 118 may assign a severity level to the issue or an alert based on the issue. The health monitor 118 may send an alert to technical support personnel with information about the issue including the affected scale unit and severity level. The alert state remains active until the issue is resolved (e.g., technical support personnel fix the problem or self-recovery occurs).

During the upgrade, the health monitor 118 may check for active alerts on the target scale unit 108t, time to time. If there are no active alerts or only active alerts with a low severity level, the target scale unit 108t is considered healthy. If the target scale unit 108t appears to be healthy, the upgrade manager 116 begins moving real tenants 108r to the target scale unit 108t. Monitoring of the target scale unit 108t continues throughout the upgrade process and real tenants 106t continue to be upgraded as long as the target scale unit is not determined to be unhealthy. The target scale unit 108t may be considered unhealthy if there is an active alert with severity level above a selected threshold level. If problems meeting a severity threshold are detected by the health monitor 118 or reported by users 114 of real tenants 106r that have been upgraded to the target scale unit 108t, the upgrade manager 116 may automatically pause the real tenant upgrade process so users are not being moved to the unhealthy target scale unit 108t. Once the issues with the target scale unit 108t are resolved, the upgrade manager 116 automatically resumes upgrading real tenants 106r scale unit.

Aspects of the health monitor 118 may allow monitoring probes and/or test scenarios to be defined. The health monitor 118 may automatically apply the scenarios using test tenants to simulate user interactions with the service 110b in the target scale unit 108t and monitor the outcome of such interactions. Monitoring may be used for assessing the health or operation of, without limitation, the target scale unit, test and/or real tenants upgraded to the target scale unit, and related components on an on-going basis during tenant upgrade process. The health monitor 118 may log the status, actions, and/or outcome of the tests, produce reports or feeds usable by the upgrade manager 116 or other connected systems, and/or send notifications or generate alerts when simulated user interactions fail or problems with the target scale unit, including services, tenants, and/or other systems or components associated with the target scale unit, are identified.

As real tenants 106t are upgraded, users 114 may experience and report problems to technical support personnel 120 (e.g., help desk staff or support engineers). Some user-initiated problem reports may occur using communication channels that are not directly integrated with the automated tenant upgrade system 100 (e.g., phone calls, e-mails, or instant messages to technical support personnel). However, such non-integrated communications may be logged in an external system 122 (e.g., a technical support system). Accordingly, aspects of the automated tenant upgrade system 100 include integration providing an interface allowing data to be shared between upgrade manager 116 and external systems 122. The health monitor 118 may also communicate with external systems 122. For example, the health monitor 118 may log any detected problems to a technical support system. Further, the upgrade manager 116 or the health monitor 118 may generate alerts (e.g., emails or text messages) that may be used to notify technical support personnel of any problems with the target scale unit 108t detected by the health monitor 118.

The upgrade manager 116 may utilize information relevant to the health of the target scale unit 108t obtained from external systems 122 to manage the tenant upgrade process. For example, the upgrade manager 116 may pause tenant upgrades when there is a user-reported problem (i.e., a trouble ticket or other record) opened in the external system 122 from a user 114 associated with a real tenant 106t that has been upgraded to target scale unit 108t. Similarly, the upgrade manager 116 may resume tenant upgrades when a trouble ticket associated with a problem in the target scale unit 108t is updated to indicate the problem is resolved or the severity of the problem is downgraded.

The hardware components of the upgrade manager 116, health monitor 118, external systems 122, of the server scale units 108 are implemented using one or more computing devices suitable for executing corresponding computer executable instructions that provide the functionality described herein. The computer executable instructions may be in the form of programs, applications, services, scripts, or other software. The computing devices may be implemented as individual servers or as server scale units. The distributed components of the automated tenant upgrade system 100 may communicate via one or more networks, such as, but not limited to, the Internet, wide area networks, and local area networks.

Although various components, such as the upgrade manager 116 and the health monitor 118, are illustrated as separate systems, some or all of the functionality of the automated tenant upgrade system 100 may be implemented in a single system and may also incorporate functionality described as being part of the external system 122.

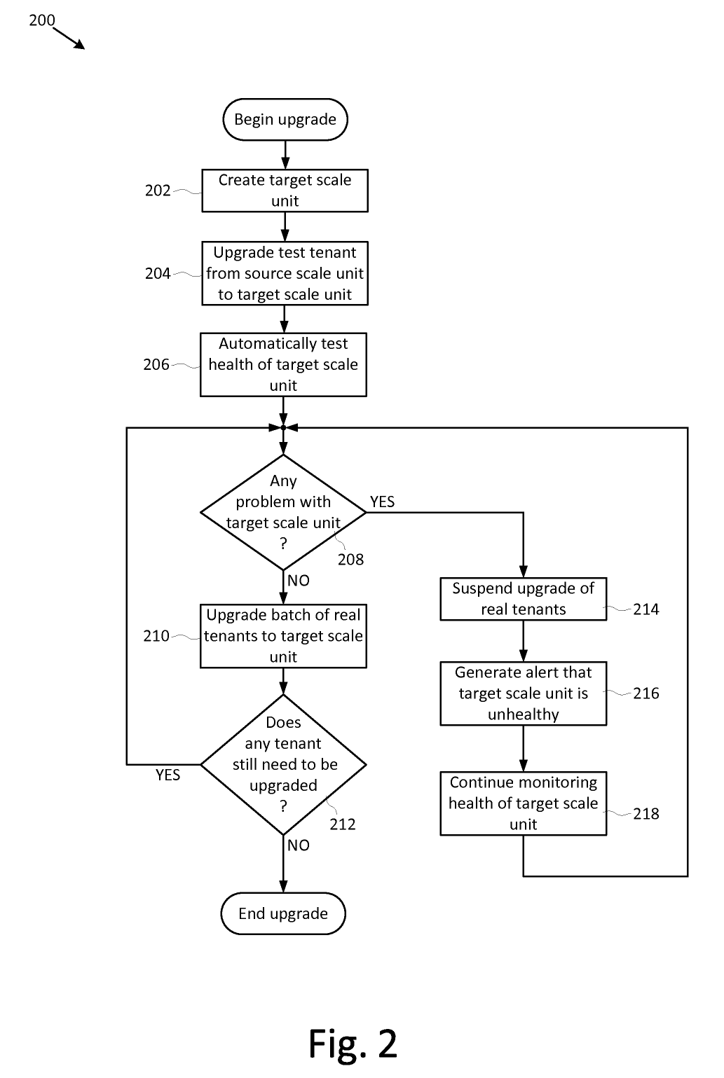

FIG. 2 is a high level flowchart illustrating aspects of a method for automatically upgrading tenants in a multi-tenant service. The automated tenant upgrade method 200 may include a target scale unit creation operation 202, a test tenant upgrade operation 204, a test tenant health check operation 206, a health check result determination 208, a real tenant upgrade operation 210 a completion determination 212, a suspension operation 214, an alert operation 216, and a suspension monitoring operation 218.

The target scale unit creation operation 202 scale unit creates a new target scale unit to which the real tenants in the source scale unit are to be relocated and performs other preparatory activities related to the tenant upgrade For example, the target scale unit creation operation 202 may also include provisioning one or more test tenants to a database in a source scale unit that may be used to test the health of the newly created target scale unit. The database may be a dedicated test database housing only test tenants; however, test tenants are not precluded from being provisioned to a production database housing real tenants.

The test tenant upgrade operation 204 begins the actual work of upgrading tenants. Aspects of the test tenant upgrade operation 204 may involve checking the scale unit to determine if a sufficient number of test databases containing only test tenants and/or a sufficient number of test tenants are available to test the target scale unit. The number of test databases and/or test tenants may be a fixed value (e.g., a preselected number) or a variable value. For example, a variable value may be calculated as a percentage of the number of real tenants slated to be upgraded. If sufficient test tenants are available, the test tenants are upgraded from the source scale unit to the target scale unit. Test tenants may be upgraded in a single batch or in multiple batches. If sufficient test databases or test tenants are not available, the upgrade will not proceed. For example, health monitoring may only occur once the target scale unit contains a minimum number of tenants or tenant databases, regardless of whether the tenants or databases are test tenants/databases or real tenants/databases. Therefore, in order to avoid upgrading real tenants until the health of the target scale unit may be checked, the number of test tenants must be at least the minimum number of tenants needed to trigger health monitoring.

The test tenant health check operation 206 monitors the health of the target scale unit using the test tenants. Health monitoring is automatically initiated once some or all of the test tenants have been upgraded to the target scale unit. Aspects of the test tenant health check operation 206 involve establishing a waiting period during which the health of the target scale unit and the test tenants upgraded to the target scale unit are evaluated. The waiting period may be defined in various ways. For example, the waiting period may be defined in time units as a minimum time (e.g., at least 30 minutes or 90 minutes) before automated upgrading of real tenants begins. The waiting period may be defined in terms of a specified battery of tests that must be successfully completed before automated upgrading of real tenants begins. For example, the test tenant health check operation 206 may involve a selected number of actions that are checked to determine if the target scale unit is properly configured or exhibits problems. Combinations of specific tests and time limits may be used (e.g., all tests completed and at least 45 minutes has passed).

Health check monitoring performed by the test tenant health check operation 206 may include basic monitoring, such as, without limitation, determining that no errors occur when provisioning test tenants in the target scale unit, verifying that the test tenant content in the target scale unit matches the test tenant content in the source scale unit, and collection of self-reported diagnostic information from the target scale unit.

Aspects of the test tenant health check operation 206 may also include automated simulation of user actions in the new scale unit. Automated tests may be accomplished by simulating user interactions with services hosted by the target scale unit using scripts, workflows, or other sequences of instructions. The simulated user interactions are executed against the target scale unit using test tenants, as if users of the test tenants were performing the actions. Most actions that can be manually performed by a user of a real tenant may be simulated. Examples of simulated user interactions include, but not limited to, administrative scenarios (e.g., creating, modifying, deleting, or listing users), authentication scenarios (e.g., logging in and out of the service), and document scenarios (e.g., creating, editing, uploading, downloading, or deleting documents).

The automated tests may also define success and/or failure conditions for the simulated user interactions. The success and/or failure conditions may be based on direct feedback or other information that would be presented to a real user in response to a command (e.g., the content of a message or dialog box) or indirect information that is generated as a result of the action (e.g., the content of logs or changes to data). Simple success/failure conditions may include detecting a message or error code resulting from a simulated action. For example, the test tenant health check operation 206 may recognize a message indicating failure when attempting to create a user as an error condition. In some cases, the mere generation of a message may be sufficient to indicate an error has occurred. In other cases, the content of the message may be parsed to determine whether an error has occurred or the severity of the error. Similarly, a log file may be parsed to find records corresponding to the attempt to create a user and the result of the attempt.

A success or failure condition may be defined in terms of an expected result. For example, when simulating a user logging in, the expected result is that the home page for the tenant will be displayed. Accordingly, if the home page for the tenant is displayed, the test tenant health check operation 206 considers the action to be successful.

More elaborate success/failure conditions may involve performing verification actions after attempting substantive actions. For example, creating a user may not produce any notification when the command is successful or may not provide any direct indication of success or failure. Instead, whether or not the new user appears in the user list may be only indication of the success or failure of the operation. In such a case, the workflow follows the actions for creating a new user with the actions for listing the users belonging to the tenant or a search for the user. In response to the search for the specific user, the service may respond in various ways, such as, a single entry user list containing the user (i.e., success), an empty list (i.e., failure), or a message indicating the user was not found (i.e., failure). In response to a command to list all users or a more general search (e.g., a last name search), a multiple entry user list may be returned. The returned list may be parsed by the test tenant health check operation 206 to verify the presence or absence of the user in the tenant.

The health check result determination 208 evaluates the information received about problems with the target scale unit obtained through monitoring of the target scale unit and collecting information about problems reported by users of real tenants that have been upgraded to the target scale unit. As previously mentioned, one measure of whether the target farm is healthy or unhealthy is the severity of any problems detected with or reported about the target farm. Severity may be measured in a variety of ways, such as, but not limited to, the types or classifications of any problems, the potential impact of problems (individually or collectively), the number of problems, the critical nature of the affected functionality, the usage frequency of the affected functionality, or a combination of such factors. For example, a problem with a single major feature, multiple minor features, or a single minor feature that is frequently used may be considered severe enough to classify the target scale unit as unhealthy.

When problems with the target scale unit are determined to be severe, the target scale unit is considered to be in an unhealthy state. Aspects of the health check result determination 208 may include comparing the severity level to a threshold value to determine whether the target scale unit is in an unhealthy state. The threshold level determines whether the problem renders the target scale unit unhealthy. For example, problems with the target scale unit may be assigned a severity level between one and four, with one being the most severe and a threshold level of two means that the target scale unit is considered unhealthy if any active problem has a severity level of one or two. Otherwise, the scale unit is considered to be in a healthy state. The target scale unit health determination may combine the severity level comparison with other factors, such as the number of problems of a given security level. For example, the target scale unit may be considered unhealthy when any level one alert is active or multiple level two alerts are active. When the scale unit is in a healthy state, the method 200 continues with the real tenant upgrade operation 210.

The health check result determination 208 uses information obtained by the test tenant health check operation 206 and continued monitoring and testing of the target scale unit. The health check result determination 208 may passively receive information about the health of the target scale unit provided by the test tenant health check operation 206 and/or actively obtain or request information about the health of the target scale unit on a continuous or periodic basis. In other words, in a passive implementation, the health check result determination 208 may be triggered when information is supplied. In a continuously active implementation, the test tenant health check operation 206 may continuously monitor a log for new information about the health of the target scale unit to provide highly responsive control over the upgrade process. In a periodically active implementation, the test tenant health check operation 206 may issue a query or parse recently logged events after the passage of a selected amount of time (e.g., every 10 minutes). The time waited by the health check result determination 208 before seeking updated information about the health of the target scale unit may be coordinated with the time needed to upgrade a batch of tenants or other relevant time period. For example, if upgrading a batch of tenants takes six to seven minutes and the upgrade of the next batch begins promptly after the upgrade of the current batch concludes, the health check result determination 208 might request information about the health of the target scale unit five minutes after starting to a batch upgrade so the current health of the target scale unit will be available when processing of the current batch ends.

The real tenant upgrade operation 210 upgrades real tenants from the source scale unit to the target scale unit. Aspects of the real tenant upgrade operation 210 include upgrading real tenants in batches. The number of real tenants upgraded in a batch may be a fixed value (e.g., 10 or 20 tenants at a time) or variable value (e.g., a selected percentage of the total real tenants to be upgraded). Upgrading tenants in batches provides additional opportunities to limit the number of customers affected by a problematic target scale unit. Monitoring of the target scale unit continues during upgrading of real tenants.

After each batch of real tenants is upgraded, a completion determination operation 212 determines whether more real tenants remain in the source scale unit waiting to be upgraded to the target scale unit. If source scale unit still contains real tenants, the method 200 continues with the health check result determination 208.

During the real tenant upgrade phase, the health check result determination 208 continues to evaluate the health of the target scale unit using the ongoing automated monitoring of test tenants. In addition, the health check result determination 208 may incorporate consideration of problems reported by the target scale unit or an associated support system. For example, if an error reporting tool logs a problem with the target scale unit occurring during use by a real tenant or a user reports an error by clicking on a submit control (i.e., button) in an error message dialog box, the health check result determination 208 evaluates the problem information when determining the health of the target scale unit.

Problem reports may also be manually recorded in a technical support system linked to the automated tenant upgrade system. For example, if a user contacts technical support personnel by telephone, email, or instant messaging, to report an issue with the multi-tenant service, the technical support personnel may enter pertinent information about the problem that allows identification of the scale unit or scale units affected by the issue (e.g., a domain name, customer name, etc.). The information entered into the technical support system may also include an indication of the severity level of the issue assigned by technical support personnel, which may be used when evaluating the problem report as part of the health check result determination 208.

The associated technical support system may automatically send messages about issues with the multi-tenant service for evaluation during the health check result determination 208. Technical support messages received by the automated tenant upgrade system are evaluated and those determined to involve a target scale unit in an active upgrade are considered when determining the health of the target scale unit. Similarly, the health check result determination 208 may query the technical support system for issues affecting the target scale unit.

If the health check result determination 208 indicates a failure of the target scale unit, the method 200 continues with a series of operations intended to remedy some or all of the problems so that real tenant upgrades may commence and to reduce, minimize, or eliminate problems real tenants that have already been upgraded are potentially facing.

The suspension operation 214 automatically halts real tenants from being upgraded if the target scale unit is in an unhealthy state. If problems are detected with the target scale unit after moving only the test tenants, no real tenants have been moved and, therefore, no customers are impacted. If problems are detected with the target scale unit after some real tenants have been upgraded, pausing or halting the upgrade process limits the number of customers that are impacted.

The alert operation 216 may generate an alert or other notification (e.g., an email) informing technical support personnel of any problems with the target scale unit 108t detected by the health monitor 118 so they may be corrected. The alert operation 216 is an optional operation.

The suspension monitoring operation 218 assesses the health of the target scale unit while tenant upgrades are suspended in a substantially similar manner to that described above for the test tenant health check operation 206 and the health check result determination 208. Once the target scale unit returns to a healthy state, the method 200 continues with the health check result determination 208.

The completion determination operation 212 checks whether any real tenants remain in the source scale unit. After all real tenants have been upgraded from the source scale unit to the target scale unit, the method 200 concludes.

Aspects of the invention may be practiced as systems, devices, and other articles of manufacture or as methods using hardware, software, computer readable media, or combinations thereof. The following discussion and associated figures describe selected system architectures and computing devices representing the vast number of system architectures and computing devices that may be utilized for practicing aspects of the invention described herein and should not be used to limit the scope of the invention in any way.

User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which the invention may be practiced may be accomplished by, without limitation, keystroke entry, touch screen entry, voice or other audio entry, gesture entry where an associated computing device is equipped with detection (e.g., camera) functionality for capturing and interpreting user gestures for controlling the functionality of the computing device, and the like.

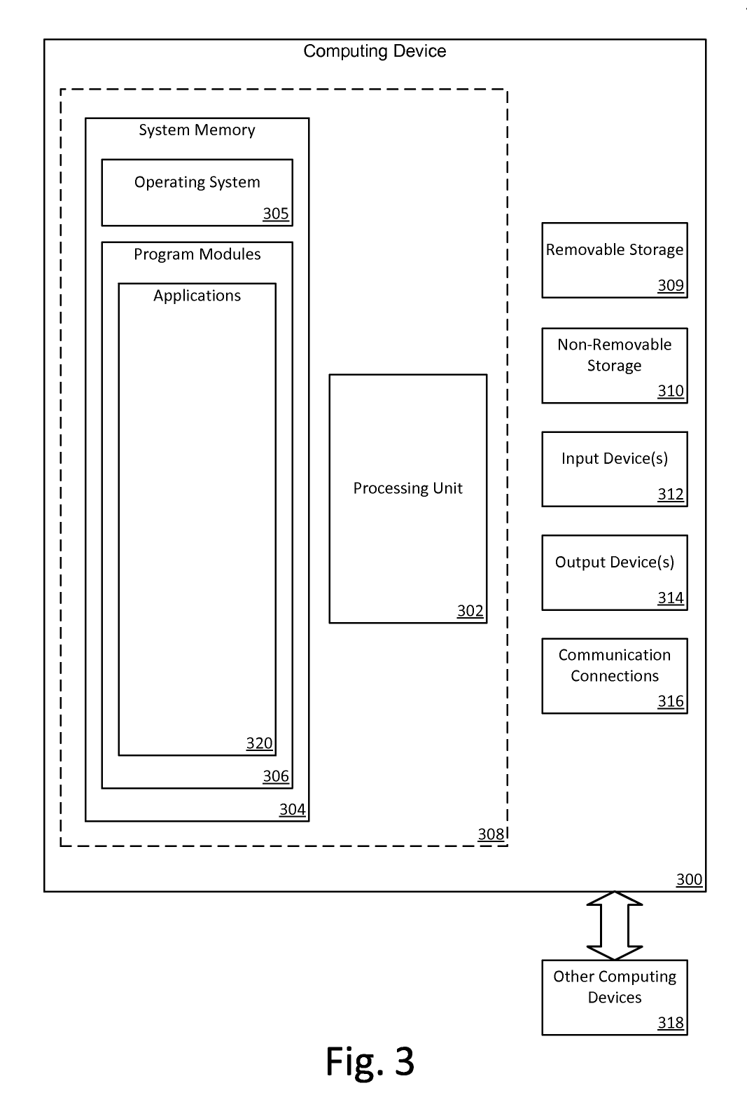

FIG. 3 is a block diagram illustrating of an architecture for a computing device with which aspects of the invention may be practiced. The computing device 300 is suitable to implement aspects of the invention embodied in a wide variety of computers and programmable consumer electronic devices including, but not limited to, mainframe computers, minicomputers, servers, personal computers (e.g., desktop and laptop computers), tablet computers, netbooks, smart phones, smartwatches, video game systems, and smart televisions, and smart consumer electronic devices.

In a basic configuration, indicated by dashed line 308, the computing device 300 may include at least one processing unit 302 and a system memory 304. Depending on the configuration and type of computing device, the system memory 304 may comprise, but is not limited to, volatile storage (e.g., random access memory), non-volatile storage (e.g., read-only memory), flash memory, or any combination of such memories. The system memory 304 may include an operating system 305 suitable for controlling the operation of the computing device 300 and one or more program modules 306 suitable for running software applications 320, including software implementing aspects of the invention described herein.

While executing on the processing unit 302, the software applications 320 may perform processes including, but not limited to, one or more of the stages of method 200. Other program modules that may be used in accordance with aspects of the invention may include electronic mail and contacts applications, word processing applications, spreadsheet applications, database applications, slide presentation applications, or computer-aided drawing application programs, etc.

In addition to the basic configuration, the computing device 300 may have additional features or functionality. For example, the computing device 300 may also include additional data storage devices (removable and/or non-removable) such as, for example, magnetic disks, optical disks, or tape. Such additional storage is illustrated by a removable storage device 309 and a non-removable storage device 310.

The computing device 300 may also have one or more input device(s) 312 such as a keyboard, a mouse, a pen, a sound input device, a touch input device, etc. The output device(s) 314 such as a display, speakers, a printer, etc. may also be included. The aforementioned devices are examples and others may be used. The computing device 300 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 304, the removable storage device 309, and the non-removable storage device 310 are all examples of computer storage media (i.e., memory storage). Computer storage media may include random access memory (RAM), read only memory (ROM), electrically erasable read-only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other article of manufacture which can be used to store information and which can be accessed by the computing device 300. Any such computer storage media may be part of the computing device 300.

Aspects of the invention may be practiced in an electrical circuit comprising discrete electronic elements, packaged or integrated electronic chips containing logic gates, a circuit utilizing a microprocessor, or on a single chip containing electronic elements or microprocessors. For example, aspects of the invention may be practiced via a system-on-a-chip (SOC) where each or many of the illustrated components may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, the functionality described herein with respect to the software applications 320 may be operated via application-specific logic integrated with other components of the computing device 300 on the single integrated circuit (chip). Aspects of the invention may also be practiced using other technologies capable of performing logical operations such as, for example, AND, OR, and NOT, including but not limited to mechanical, optical, fluidic, and quantum technologies. In addition, aspects of the invention may be practiced within a general purpose computer or in any other circuits or systems.

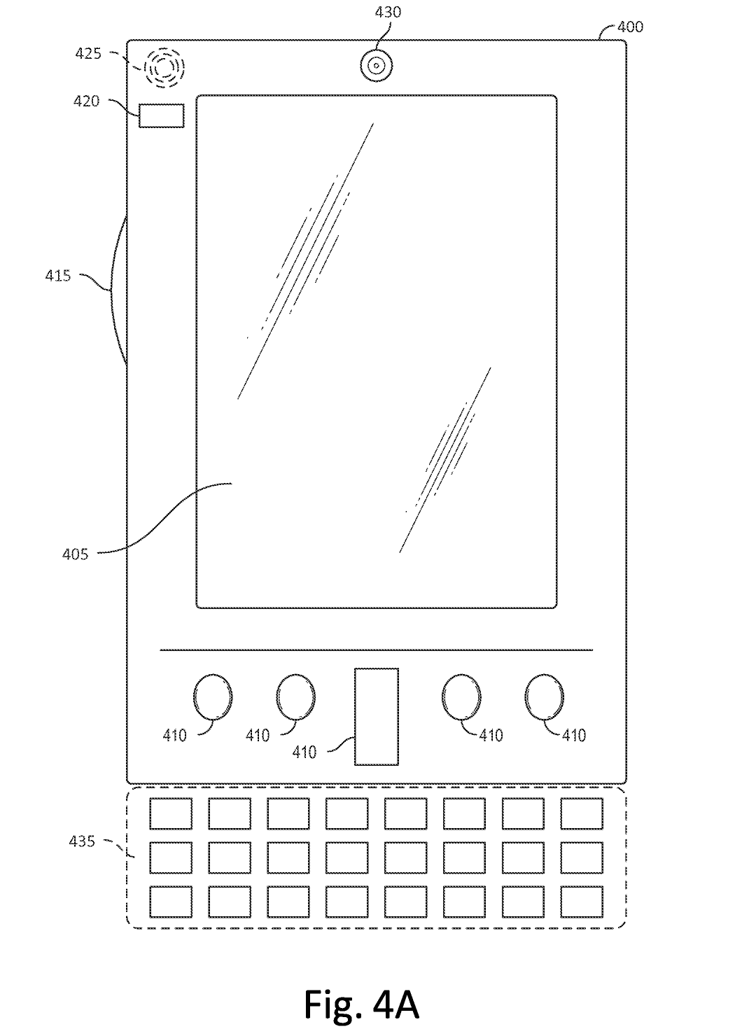

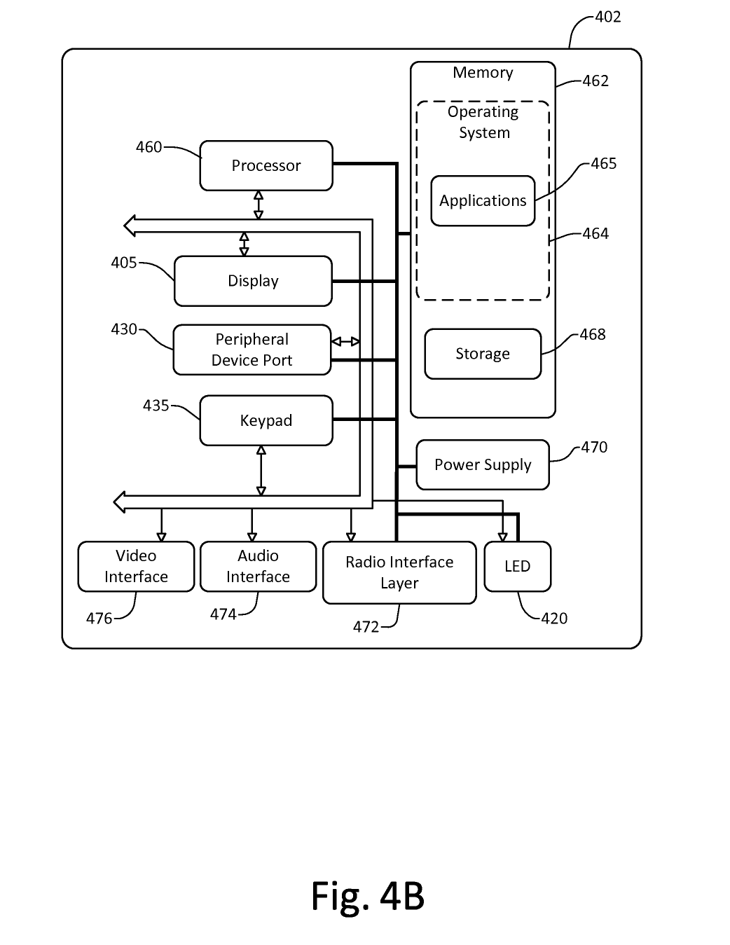

FIG. 4A illustrates a mobile computing device 400 suitable for practicing aspects of the present invention. Examples of suitable mobile computing devices include, but are not limited to, a mobile telephone, a smart phone, a tablet computer, a surface computer, and a laptop computer. In a basic configuration, the mobile computing device 400 is a handheld computer having both input elements and output elements. The mobile computing device 400 typically includes a display 405 and one or more input buttons 410 that allow the user to enter information into the mobile computing device 400. The display 405 of the mobile computing device 400 may also function as an input device (e.g., a touch screen display). If included, an optional side input element 415 allows further user input. The side input element 415 may be a rotary switch, a button, or any other type of manual input element. The mobile computing device 400 may incorporate more or fewer input elements. For example, the display 405 need not be a touch screen. The mobile computing device 400 may also include an optional keypad 435. Optional keypad 435 may be a physical keypad or a “soft” keypad generated on the touch screen display. The output elements include the display 405 for showing a graphical user interface, a visual indicator 420 (e.g., a light emitting diode), and/or an audio transducer 425 (e.g., a speaker). The mobile computing device 400 may incorporate a vibration transducer for providing the user with tactile feedback. The mobile computing device 400 may incorporate input and/or output ports, such as an audio input (e.g., a microphone jack), an audio output (e.g., a headphone jack), and a video output (e.g., a HDMI port) for sending signals to or receiving signals from an external device.

FIG. 4B is a block diagram illustrating an architecture of for a mobile computing device with which aspects of the invention may be practiced. As an example, the mobile computing device 400 may be implemented in a system 402 such as a smart phone capable of running one or more applications (e.g., browsers, e-mail clients, notes, contact managers, messaging clients, games, and media clients/players).

One or more application programs 465 may be loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. The system 402 also includes a non-volatile storage area 468 within the memory 462. The non-volatile storage area 468 may be used to store persistent information that should not be lost if the system 402 is powered down. The application programs 465 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device 400, including software implementing aspects of the invention described herein.

The system 402 has a power supply 470, which may be implemented as one or more batteries. The power supply 470 might further include an external power source, such as an AC adapter or a powered docking cradle that supplements or recharges the batteries.

The system 402 may also include a radio 472 that performs the function of transmitting and receiving radio frequency communications. The radio 472 facilitates wireless connectivity between the system 402 and the outside world via a communications carrier or service provider. Transmissions to and from the radio 472 are conducted under control of the operating system 464. In other words, communications received by the radio 472 may be disseminated to the application programs 465 via the operating system 464, and vice versa.

The visual indicator 420 may be used to provide visual notifications, and/or an audio interface 474 may be used for producing audible notifications via the audio transducer 425. As shown, the visual indicator 420 may be a light emitting diode (LED). These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425, the audio interface 474 may also be coupled to a microphone to receive audible input, such as to facilitate a telephone conversation. The microphone may also serve as an audio sensor to facilitate control of notifications, as will be described below. The system 402 may further include a video interface 476 that enables an operation of an on-board camera 430 to record still images, video stream, and the like.

A mobile computing device 400 implementing the system 402 may have additional features or functionality. For example, the mobile computing device 400 may also include additional data storage devices (removable and/or non-removable) such as, magnetic disks, optical disks, or tape. Such additional storage is illustrated by the non-volatile storage area 468. A peripheral port 430 allows external devices to be connected to the mobile computing device 400. External devices may provide additional features or functionality to the mobile computing device 400 and/or allow data to be transferred to or from the mobile computing device 400.

Data/information generated or captured by the mobile computing device 400 and stored via the system 402 may be stored locally on the mobile computing device 400, as described above, or the data may be stored on any number of storage media that may be accessed by the device via the radio 472 or via a wired connection between the mobile computing device 400 and a separate computing device associated with the mobile computing device 400, for example, a server computer in a distributed computing network, such as the Internet. As should be appreciated such data/information may be accessed via the mobile computing device 400 via the radio 472 or via a distributed computing network. Similarly, such data/information may be readily transferred between computing devices for storage and use according to well-known data/information transfer and storage means, including electronic mail and collaborative data/information sharing systems.

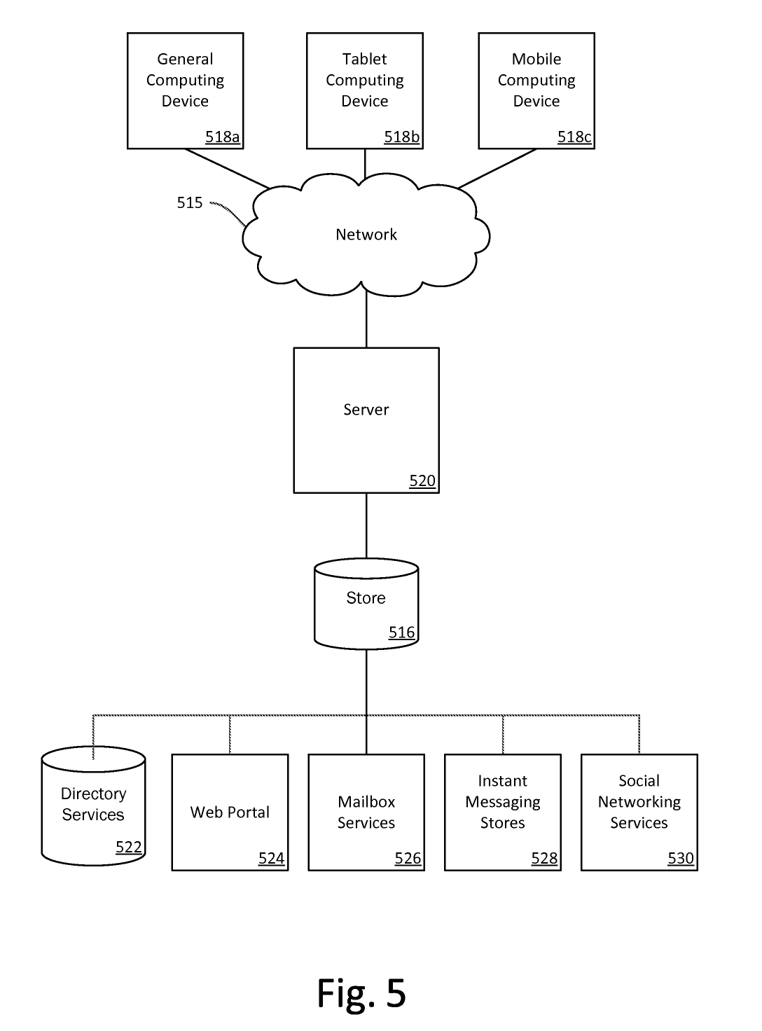

FIG. 5 is a simplified block diagram of a distributed computing system for practicing aspects of the invention. Content developed, interacted with, or edited in association with software applications, including software implementing aspects of the invention described herein, may be stored in different communication channels or other storage types. For example, various documents may be stored using a directory service 522, a web portal 524, a mailbox service 526, an instant messaging store 528, or a social networking site 530. The software applications may use any of these types of systems or the like for enabling data utilization, as described herein. A server 520 may provide the software applications to clients. As one example, the server 520 may be a web server providing the software applications over the web. The server 520 may provide the software applications over the web to clients through a network 515. By way of example, the client device may be implemented as the computing device 300 and embodied in a personal computer 518a, a tablet computer 518b, and/or a mobile computing device (e.g., a smart phone) 518c. Any of these client devices may obtain content from the store 516.

The description and illustration of one or more embodiments provided in this application are intended to provide a complete thorough and complete disclosure the full scope of the subject matter to those skilled in the art and not intended to limit or restrict the scope of the invention as claimed in any way. The aspects, embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternatives falling within the spirit of the broader aspects of the general inventive concept embodied in this application that do not depart from the broader scope of the claimed invention.

What is claimed is:

1. A method for automatically upgrading tenants from a source scale unit to a target scale unit in a multi-tenant service, the method comprising:
upgrading test tenants from the source scale unit to the target scale unit;
testing the health of the target scale unit after upgrading test tenants to the target scale unit; and
upgrading real tenants from the source scale unit to the target scale unit if the target scale unit is in a healthy state.

2. The method of claim 1 further comprising the act of continuing to test the health of the target scale unit while upgrading real tenants from the source scale unit to the target scale unit.

3. The method of claim 2 wherein the real tenants are upgraded in batches, further comprising the act of determining that target scale unit is in a healthy state after each batch of real tenants is upgraded to the target scale unit before upgrading the next batch of real tenants to the target scale unit.

4. The method of claim 2 further comprising the act of suspending upgrades of real tenants from the source scale unit to the target scale unit automatically if the target scale unit is in an unhealthy state.

5. The method of claim 4 further comprising the act of resuming upgrades of real tenants from the source scale unit to the target scale unit automatically when the target scale unit is restored to a healthy state.

6. The method of claim 1 wherein the act of testing the health of the target scale unit after upgrading test tenants to the target scale unit comprises the acts of:
simulating user activities in the target scale unit using the test tenants;
obtaining results for the simulated user activities; and
determining whether the target scale unit is in a healthy state or an unhealthy state based on the results.

7. The method of claim 6 wherein the act of determining whether the target scale unit is in a healthy state or an unhealthy state based on the results comprises the act of flagging the target scale unit as unhealthy when the result indicates the simulated user activity was unsuccessful.

8. The method of claim 6 wherein the act of determining whether the target scale unit is in a healthy state or an unhealthy state based on the results comprises the acts of:
identifying a problem when the results indicate one of the simulated user activities was unsuccessful;
determining a severity value based on the identified problems; and
flagging the target scale unit as unhealthy if the severity value meets a severity threshold.

9. The method of claim 1 further comprising the acts of:
receiving information that the target scale unit is in an unhealthy state based on a report from a user in a real tenant that has been upgraded to the target scale unit; and
suspending upgrades of real tenants from the source scale unit to the target scale unit automatically until the target scale unit is restored to a healthy state.

10. The method of claim 1 further comprising the act of generating an alert indicating the target scale unit is in an unhealthy state.

11. An automated tenant upgrade system in communication with a multi-tenant service including a source scale unit, a target scale unit, real tenants provisioned to the source scale unit, and test tenants provisioned to the source scale unit, the automated tenant upgrade system comprising:
a scale unit health monitor operable to test operation of the target scale unit;
an upgrade manager in communication with the scale unit health monitor, the upgrade manager operable to:
upgrade the test tenants from the source scale unit to the target scale unit;
initiate testing of the target scale unit by the scale unit health monitor after upgrading test tenants to the target scale unit;
receive information about the target scale unit from the scale unit health monitor;
upgrade real tenants from the source scale unit to the target scale unit while the information indicates that the target scale unit is healthy;
suspend upgrades of real tenants automatically when the information indicates that the target scale unit is unhealthy; and
resume upgrades of real tenants automatically when the information indicates that the target scale unit is no longer unhealthy.

12. The automated tenant upgrade system of claim 11 wherein the upgrade manager is further operable to upgrade the real tenants in batches and verify that the target scale unit is healthy before starting to upgrade each batch of real tenants.

13. The automated tenant upgrade system of claim 11 wherein at least one of the scale unit health monitor and the upgrade manager is further operable to generate an alert when the target scale unit is determined to be unhealthy based on testing by the scale unit health monitor.

14. The automated tenant upgrade system of claim 11 wherein the scale unit health monitor is further operable to execute a sequence of instructions that simulate user interaction with the target scale unit and monitor the response of the target scale unit to the sequence of instructions.

15. The automated tenant upgrade system of claim 14 wherein the scale unit health monitor is further operable to notify the upgrade manager that the target scale unit is unhealthy when a sequence of instructions was not successfully completed.

16. The automated tenant upgrade system of claim 11 wherein at least one of the scale unit health monitor and the upgrade manager is in communication with a technical support system providing information about the target scale unit, the information comprising records of problems reported by users from real tenants that have been upgraded to the target scale unit indicating severity levels for the problems and whether the problems have been resolved.

17. The automated tenant upgrade system of claim 14 wherein the information about the target scale unit provided by the scale unit health monitor or the technical support system provides a determination of whether the target scale unit is healthy or unhealthy.

18. The automated tenant upgrade system of claim 14 wherein at least one of the scale unit health monitor and the upgrade manager is further operable to determine whether the target scale unit is healthy or unhealthy based on an evaluation of severity for problems detected with the target scale unit.

19. The automated tenant upgrade system of claim 11 further comprising:
one or more databases in the source scale unit operable to store real tenants; and
one or more test-only databases in the source scale unit operable to store only test tenants; and
wherein the upgrade manager is further operable to cancel an upgrade if the source scale unit does not contain a selected number of test-only databases.

20. A computer readable medium containing computer executable instructions which, when executed by a computer, perform a method of automatically upgrading tenants from a source scale unit to a target scale unit in a multi-tenant service, the method comprising:
upgrading test tenants from the source scale unit to the target scale unit;
testing the health of the target scale unit after upgrading test tenants to the target scale unit;
upgrading real tenants in batches from the source scale unit to the target scale unit if the target scale unit is in a healthy state, each batch containing a number of real tenants from the source scale unit;
continuing to test the health of the target scale unit while upgrading real tenants to the target scale unit;
preventing a batch of real tenants from starting to be upgraded automatically if an alert with a selected severity level is active for the target scale unit;
resuming upgrades of real tenants automatically if no alerts with the selected severity level are active for the target scale unit.
